(19) United States
(12) Patent Application Publication
(10) Pub. No.: US 2011/0247132 A1
(43) Pub. Date: Oct. 13, 2011

(54) Fixed collapsable toilet for recreational vehicles of small spaces with movable walls

(76) Inventor: Phillip Charles Watts, Longmont, CO (US)

(21) Appl. No.: 13/065,289

(22) Filed: Mar. 18, 2011

Related U.S. Application Data
(60) Provisional application No. 61/342,176, filed on Apr. 9, 2010.

(51) Int. Cl. B60R 15/04

(52) U.S. Cl. 4/458

(57) ABSTRACT

A fixed or permanently installed collapsible dry toilet that when mounted to movable walls as in a Recreational Vehicle or stationary walls, that can quickly be adjusted to any height with height stops for toddlers, 16.5 inches for the American with Disabilities Act of 1992 and 19 inches for seniors. When not in use the toilet seat is hinged so that the seat folds down and hugs the wall and is only 1.6 inches thick when collapsed and is intended for small spaces that can have multiple uses since the toilet can fold into the wall and not occupy any space. A biodegradable plastic bag is placed in the center of the seat and is supported by a replaceable fishnet basket. The plastic bag is of sufficient size to cover the entire toilet seat so that each user has a clean unused covering over the seat. Upon completion the disposable bag is tossed in any garbage receptacle. The toilet design is intended to never need cleaning, is easily adjusted to various heights from the floor to seat, and takes up minimal space when collapsed, can be operated in freezing temperatures and does not use water. The height can be modified easily for custom heights for short to tall people. The toilet is welded aluminum for durability and low weight under four pounds and the seat is covered with ⅛^{th} inch closed foam insulation to isolate any uncomfortable conduction of heat from the aluminum seat and allows the human body to quickly warm the seat surface. This is a no leg implementation that leaves the floor below the toilet clear such that clear space under the toilet can be made available for other uses such as a shower, hall or cabinet.

This application describes a fixed or permanently installed collapsible dry toilet that when mounted to movable walls as in a Recreational Vehicle or stationary walls, that can quickly be adjusted to any height with height stops for toddlers, 16.5 inches for the American with Disabilities Act of 1992 and 19 inches for seniors. When not in use the toilet seat is hinged so that the seat folds down and hugs the wall and is only 1.6 inches thick when collapsed and is intended for small spaces that can have multiple uses since the toilet can fold into the wall and not occupy any space. A biodegradable plastic bag is placed in the center of the seat and is supported by a replaceable fishnet basket. The plastic bag is of sufficient size to cover the entire toilet seat so that each user has a clean unused covering over the seat. Upon completion the disposable bag is tossed in any garbage receptacle. The toilet design is intended to never need cleaning, is easily adjusted to various heights from the floor to seat, and takes up minimal space when collapsed, can be operated in freezing temperatures and does not use water. The height can be modified easily for custom heights for short to tall people. The toilet is welded aluminum for durability and low weight under four pounds and the seat is covered with ⅛^{th} inch closed foam insulation to isolate any uncomfortable conduction of heat from the aluminum seat and allows the human body to quickly warm the seat surface. This is a no leg implementation that leaves the floor below the toilet clear such that clear space under the toilet can be made available for other uses such as a shower, hall or cabinet.

### BACKGROUND OF THE INVENTION

1. Field of the Invention

The invention relates to fixed permanent toilets and disposable biodegradable bags for use with fixed permanent toilets.

2. Description of the Prior Art

This apparatus is a collapsible toilet that is hinged to hug a support wall and is intended to liberate space in confined small areas with movable walls, and is intended to be all season no freezing as it uses no water and never needs cleaning. Small spaces such as the interior of a recreational vehicle or camp trailer or truck cab. The toilet seat can be fitted with a cushion so the seat can be used as an optional seat.

Disposable bags for portable toilets are disclosed in US Patent 2001/0034904 A1.

Desirable feature that allows the multiple use of the same space that a fixed toilet normally occupies with its large footprint. Folding against the wall makes the space available for other activities. The toilet could be covered by a cloth or cabinet door to conceal it. With slide out rooms in RVs, the clear open floor has no plumbing to interfere with a moving wall.

### SUMMARY OF THE INVENTION

A collapsible fixed toilet that hugs a wall so the space can be of multiple use and the floor space beneath the toilet is clear and free of any attachment to the floor.

A collapsible fixed toilet that has adjustable heights with detents for toddler, 16.5 inch and 19.5 inch seat heights for seniors.

A never need cleaning collapsible fixed toilet due to the biodegradable plastic waste bag the covers the seat for each use.

A collapsible fixed toilet, that can be operated in freezing temperatures.

A collapsible fixed toilet equipped with a removable web support basket that supports the biodegradable plastic waste bag.

BRIEF SESCRIPTION OF THE DRAWINGS

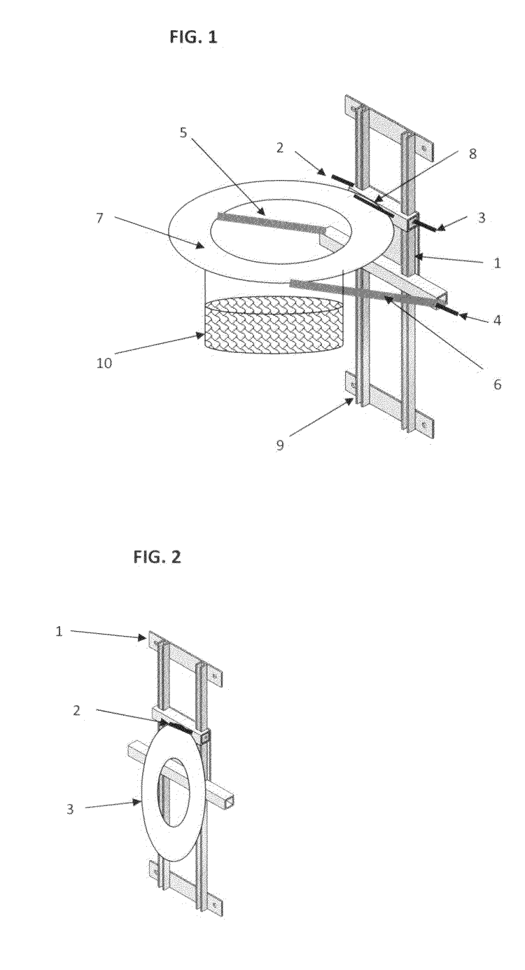

FIG. 1 is a setup toilet ready for use.

FIG. 2 is a collapsed toilet with the seat only protruding 1.6 inches from the wall.

### DESCRIPTION OF THE PREFERRED EMBODIMENT

FIGS. 1 and 2 show an embodiment of the collapsible fixed toilet with the support bag reference 10 that is removable if necessary. Reference number 9 of FIG. 1 identifies the solid welded aluminum frame that constrains the slide, reference 1 that moves to pin holes of preselected heights via two opposing pins, reference numbers 2 and 3 that are compressed with an elastic cord stretched between reference number 2 and 3. The cord could also be a spring compression applied to the pin shaft as well. Holes drilled into the two channels of aluminum of the frame, reference number 9 are pre drilled for 19.5 inches, 16.5 inches for the

What is claimed is:

1. A collapsible fixed toilet that is mounted to a movable wall or sliding or telescoping rooms of Recreational Vehicles without running water to toilet.

2. A collapsible fixed toilet that hugs a wall so the space can be of multiple use and the floor space beneath the toilet is clear and free of any attachment to the floor.

3. A collapsible fixed toilet that has adjustable heights with detents for toddler, 16.5 inch and 19.5 inch seat heights for seniors.

4. A never need cleaning collapsible fixed toilet due to the biodegradable plastic waste bag the covers the seat for each use.

5. A collapsible fixed toilet that can be operated in freezing temperatures.

6. A collapsible fixed toilet equipped with a removable web support basket that supports the biodegradable plastic waste bag.

7. A safety pin to ensure that a deployed seat in the 90 degree use position will remain in said position until intentionally collapsed to the storage position.

8. A collapsible fixed toilet that can be fitted with a cushion to sit on as an extra sitting space.

9. A collapsible fixed toilet can be fitted with a cover to allow storage of a used waste bag that could be saved for multiple use.

10. A collapsible fixed toilet welded so as no parts can be removed by vandalism if installed in a public facility.

11. A collapsible fixed toilet of solid aluminum that can be hosed down and allows the clear space below it to be hosed down in a public facility.
